(19) United States
(12) Patent Application Publication
(10) Pub. No.: US 2006/0117293 A1
(43) Pub. Date: Jun. 1, 2006

(54) Method for designing an overlay mark

(76) Inventors: Nigel Smith, Hsinchu (TW); Chun-hung Ko, Taipei (TW); Yi-sha Ku, Hsinchu (TW); Shih Chun Wang, Taipei (TW)

Correspondence Address: PERKINS COIE LLP, POST OFFICE BOX 1208, SEATTLE, WA, 98111-1208, US

(21) Appl. No.: 11/288,834

(22) Filed: Nov. 28, 2005

(30) Foreign Application Priority Data
Nov. 30, 2004 (TW) 93136840

(51) Int. Cl. G06F 17/50

(52) U.S. Cl. 716/19

(57) ABSTRACT

Precision in scatterometry measurements is improved by designing the reticle, or the target grating formed by the reticle, for greater overlay measurement sensitivity. Parameters of the structure and material of the substrate are first determined. These parameters may include the material composition, thickness, and sidewall angles of the sample substrate. The target grating is then designed so that the overlay measurement, on the sample substrate, is made more sensitive. A suitable measurement wavelength is selected, optionally via computer simulation, to further improve the sensitivity. This method increases the change of reflective signatures with overlay offsets, and thus improves the sensitivity of overlay measurement.

### BACKGROUND OF THE INVENTION

This application claims priority to Taiwan Patent Application No. 93136840, filed Nov. 30, 2004, which is hereby incorporated by reference.

The field of the invention is manufacturing semiconductor and similar micro-scale devices. More specifically, the invention related to scatterometry, which is a technique for measuring micro-scale features, based on the detection and analysis of light scattered from the surface. Generally, scatterometry involves collecting the intensity of light scattered or diffracted by a periodic feature, such as a grating structure as a function of incident light wavelength or angle. The collected signal is called a signature, since its detailed behavior is uniquely related to the physical and optical parameters of the structure grating.

Scatterometry is commonly used in photolithographic manufacture of semiconductor devices, especially in overlay measurement, which is a measure of the alignment of the layers which are used to form the devices. Accurate measurement and control of alignment of such layers is important in maintaining a high level of manufacturing efficiency.

Microelectronic devices and feature sizes continue to get ever smaller. The requirement for the precision of overlay measurement of 130 nm node is 3.5 nm, and that of 90 nm node is 3.2 nm. For the next-generation semiconductor manufacturing process of 65 nm node, the requirement for the precision of overlay measurement is 2.3 nm. Since scatterometry has good repeatability and reproducibility, it would be advantageous to be able to use it in the next generation process. However, conventional bright-field metrology systems are limited by the image resolution. Consequently, these factors create significant technological challenges to the use of scatterometry with increasingly smaller features.

Scatterometry measurements are generally made by finding the closest fit between an experimentally obtained signature and a second known signature obtained by other ways and for which the value of the property or properties to be measured are known. Commonly, the second known signature (also called the reference signature) is calculated from a rigorous model of the scattering process. It may occasionally be determine experimentally. Where a modeled signature is used as the reference signature, the calculations may be performed once and all signatures possible for the parameters of the grating that may vary are stored in a library. Alternatively, the signature is calculated when needed for test values of the measured parameters. However the reference signature is obtained, a comparison of the experimental and reference signature is made. The comparison is quantified by a value which indicates how closely the two signatures match.

Typically, the fit quality is calculated as the root-mean-square difference (or error) (RMSE) between the two signatures, although other comparison methods may be used. The measurement is made by finding the reference signal with the best value of fit quality to the experimental signature. The measurement result is then the parameter set used to calculate the reference signal. Alternatively, in the case of experimentally derived reference signatures, the value of the known parameters is used to generate the experimental signature. As with any real system, the experimental signature obtained from the metrology system or tool will contain noise. Noise creates a lower limit to the fit quality that can be expected. The system cannot differentiate measurement changes which cause changes in the fit quality lower than this noise-dependent lower limit. The sensitivity of the system to a change in any measurement parameter is the smallest that will cause the reference signal to change by an amount that, expressed as a fit quality to the original reference signature, would just exceed this lowest detectable limit. As a result, theoretically generated reference signals may be used to determine system sensitivity. If the fit quality calculated by matching one reference signal to another does not exceed the smallest detectable level, then the system would be unable to detect the two signatures as different and would not be sensitive to the change in measurement parameters they represent. Consequently, sensitivity is an important factor in using scatterometry in the next generation process.

Scatterometers, or scatterometry systems, are usually divided into spectroscopic reflectometers, specular spectroscopic ellipsometers, or angular scatterometers. Spectroscopic and specular systems record the change in scattered light as a function of incident wavelength for fixed angle of incidence. Angular scatterometers record the change in scattered light intensity as a function of angle for fixed illumination wavelength. All types of scatterometers commonly operate by detecting light scattered in the zeroth (spectral) order, but can also operate by detection at other scattering orders. All of these methods use a periodic grating structure as the diffracting element. Hence, the methods and systems described are suitable for use with these three kinds of metrology systems for overlay measurement, and any others using a periodic grating as the diffracting element.

It is an object of the invention to provide scatterometry methods and systems having greater sensitivity, and which can therefore offer improved precision of overlay measurement.

### BRIEF DESCRIPTION OF THE DRAWINGS

FIG. 1a is flow chart of a method for improving sensitivity by optimizing the geometry of the grating.

FIG. 1b is a sub-flow chart showing calculation of ASD in FIG. 1a.

FIG. 2 is representative diagram of a substrate having first and second target gratings.

FIG. 3 shows angular scatterometry of the substrate shown in FIG. 2.

FIG. 4 shows an example for the reflective signatures of angular scatterometry.

FIG. 5 shows simulation results for one incident wavelength of laser light.

FIG. 6 is the contour plot of FIG. 5.

### DETAILED DESCRIPTION

The characteristics of the scattering signature in scatterometry are controlled by the dimensions of the grating, and the composition, thickness and sidewall angles of the materials used. The material and the film thicknesses are determined by the semiconductor device, or similar micro-scale device. The sidewall angle of patterned elements is determined by the lithography and etching processes. The only parameters that can be selected solely for purposed of scatterometry are the geometry of the target. The geometry of the target includes its pitch and line-to-space ratio of the grating. For overlay measurement where two different films are patterned, each layer may be patterned with a different pitch and line:space ratio, and in addition a deliberate offset may be introduced between the two grating patterns.

The wavelength of the incident light will also affect the sensitivity of angular scatterometers, providing a further parameter which may allow optimization of the measurement. Equivalently, the incident angle may be optimised for spectral reflectometers and spectrometers.

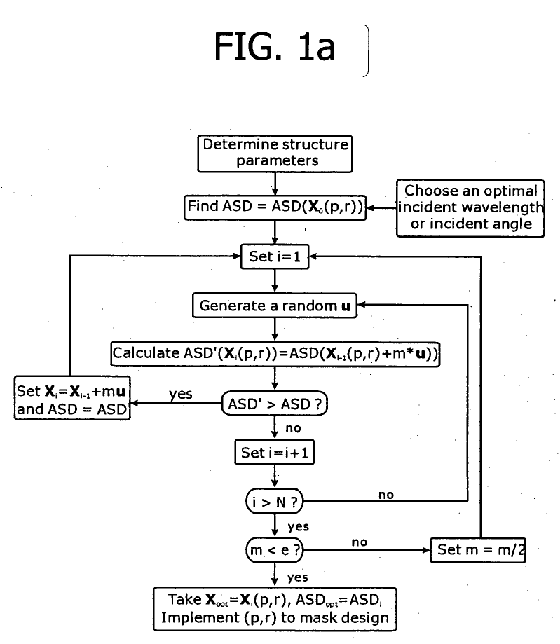

A method is provided for improving the sensitivity of overlay measurement by optimizing the geometry of the gratings. A computer simulation analysis is used to choose a suitable wavelength for angular scatterometry, and hence to further increase the change in signatures with overlay offset. The sensitivity of overlay measurement is improved. FIG. 1a shows a procedure diagram in which the algorithm is not restricted to optimization of specific parameters. p and r are the pitch and line-to-space ratio of the grating, respectively. X is the position vector in the p-r plane. X represents one set of pitch and line to space ratio of a selected range. m and u are the step size and direction vector, respectively. U represents the moving direction toward the optimum grating structure. N is the maximum number of iterations; e is the minimum step size. FIG. 1b shows calculation of ASD. The steps shown in FIGS. 1a and 1b (except for the last step in FIG. 1a) may be performed as mathematical steps carried out after entry of the structure, substrate or layer parameters and the wavelength parameter.

Reflective intensity can be described as:

$$R = \vert U ( {z}_{2} ) \times {U ( {z}_{2} )}^{*} \vert$$

$$U ( {z}_{1} ) = exp [ - ( {z}_{2} - {z}_{1} ) M ] U ( {z}_{2} )$$

$$M = - i [ \begin{matrix}0 & {k}_{0} I \\ {k}_{0} \frac{{K}_{z}^{{( i - v )}^{2}}}{{K}_{0}^{2}} & 0\end{matrix} ]$$

z₁ and z₂ are the position of the incident plane and output plane respectively; M is transformation matrix; k₀ is the wave number of incident light at region z<z₁; k_{z} is the wave number of incident light along the optical path (z-axis) at grating region z₁<z<z₂; (i-v) is the order number of grating diffraction; I is identity matrix.

In the case of an angular scatterometer, k_{z}^{(i-v)2} is a function of grating pitch, grating line to space ratio, overlay error and incident angle of light. Thus, the reflective intensity can be expressed as:
R=|U(z₂)×U(z₂)*|=R(pitch,LSratio,θ₁,Δ_{OL})

If the grating pitch and line to space ratio are fixed, then the average standard deviation, ASD can be defined as following equation:

$$ASD = \frac{1}{{θ}_{final} - {θ}_{start}} {\sum }_{{θ}_{i} = {θ}_{starti}}^{{θ}_{final}} δ ( {θ}_{i} ) , \\ δ ( {θ}_{i} ) = \sqrt{{\sum }_{Δ {OL}_{j}}^{J} {( R ( {θ}_{i} , {Δ}_{{OL}_{j}} ) - \overline{R ( {θ}_{i} , {Δ}_{{OL}_{j}} )} )}^{2} / N}$$

θₛₜₐᵣₜ is the starting scan angle of the incident laser beam, θ_{final} is the final scan angle of the incident laser beam, R(θᵢ,Δ_{OL}_{ⱼ}) is the signature of reflective light at overlay error Δ_{OLj}, δ(θᵢ) is the standard deviation calculated from the reflective intensity R(θᵢ,Δ_{OLj})|_{j=1,2 . . . ,J} of different overlay error at the incident angle θᵢ. Therefore, ASD represents the discrepancy of the reflected signatures with different overlay error. The larger ASD is, the more discrepancy between the signatures. The more discrepancy, the more easily the measurement system can discriminate different overlay error, Conversely, the lower the discrepancy, the worse the measurement sensitivity will be to the overlay error.

In reflectometer case, k_{z}^{(i-v)2} is functions of grating pitch, grating line to space ratio, overlay error and wavelength of incident light. Thus, the reflected light intensity can be expressed as:
R=|U(z₂)×U(z₂)*|=R(pitch,LSratio,λᵢ,Δ_{OL})

If the grating pitch and line to space ratio are fixed, then the average standard deviation, ASD can be expressed as following equation:

$$ASD = \frac{1}{{λ}_{final} - {λ}_{start}} {\sum }_{{λ}_{i} = {λ}_{starti}}^{{λ}_{final}} δ ( {λ}_{i} ) , \\ δ ( {λ}_{i} ) = \sqrt{{\sum }_{Δ {OL}_{j}}^{J} {( R ( {λ}_{i} , {Δ}_{{OL}_{j}} ) - \overline{R ( {λ}_{i} , {Δ}_{{OL}_{j}} )} )}^{2} / N}$$

λₛₜₐᵣₜ is the starting scan wavelength of the incident laser beam, λ_{final} is the final scan wavelength of the incident laser beam.

In ellipsometer case, k_{z}^{(i-v)2} is functions of grating pitch, grating line to space ratio, overlay error and wavelength of incident light. Thus, the reflected light intensity can be expressed as:
R=|U(z₂)xU(z₂)*|=|Rₚ×R*ₚ|+|Rₛ×R*ₛ|

Rₚ and Rₛ are the amplitudes of reflective p-polarized and s-polarized light respectively. They are functions of grating pitch, grating line to space ratio, overlay error and wavelength of incident light.

$$\frac{{R}_{p}}{{R}_{s}} = tan ( ψ ) {ⅇ}^{iΔ}$$

ψ and Δ are the parameters of the ellipsometer. They are also functions of grating pitch, grating line to space ratio, overlay error and wavelength of incident light.
ψ=ψ(pitch,LSratio,λᵢ,Δ_{OL})
Δ=Δ(pitch,LSratio,λᵢ,Δ_{OL})

If the grating pitch and line to space ratio are fixed, then the average standard deviation, ASD can be expressed as following equation:

$${ASD}_{ψ} = \frac{1}{{λ}_{final} - {λ}_{start}} {\sum }_{{λ}_{i} = {λ}_{starti}}^{{λ}_{final}} δ ( {λ}_{i} ) , \\ δ ( {λ}_{i} ) = \sqrt{{\sum }_{Δ {OL}_{j}}^{J} {( ψ ( {λ}_{i} , {Δ}_{{OL}_{j}} ) - \overline{ψ ( {λ}_{i} , {Δ}_{{OL}_{j}} )} )}^{2} / N}$$

$${ASD}_{Δ} = \frac{1}{{λ}_{final} - {λ}_{start}} {\sum }_{{λ}_{i} = {λ}_{starti}}^{{λ}_{final}} δ ( {λ}_{i} ) , \\ δ ( {λ}_{i} ) = \sqrt{{\sum }_{Δ {OL}_{j}}^{J} {( Δ ( {λ}_{i} , {Δ}_{{OL}_{j}} ) - \overline{Δ ( {λ}_{i} , {Δ}_{{OL}_{j}} )} )}^{2} / J}$$

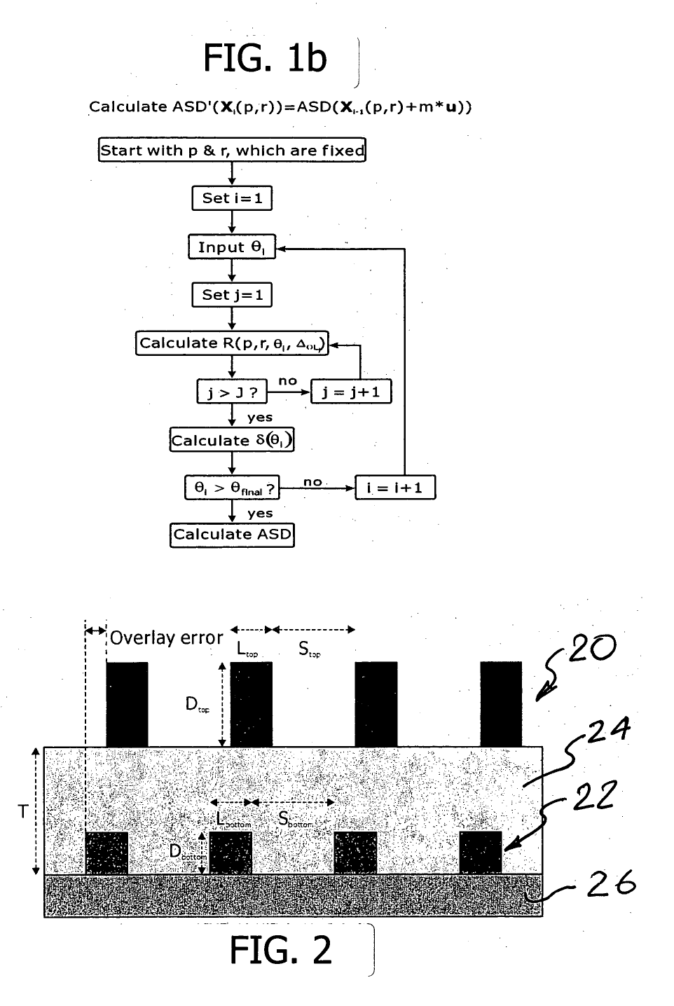

FIG. 2 shows an example. In FIG. 2, the target has two gratings 20 and 22 with the same pitch, in the top layer and bottom layer, respectively. An interlayer 24 is between the top and bottom layer and the substrate 26. The material of the top grating, interlayer, bottom grating, and substrate is photo-resist, PolySi, SiO2, and silicon, respectively.

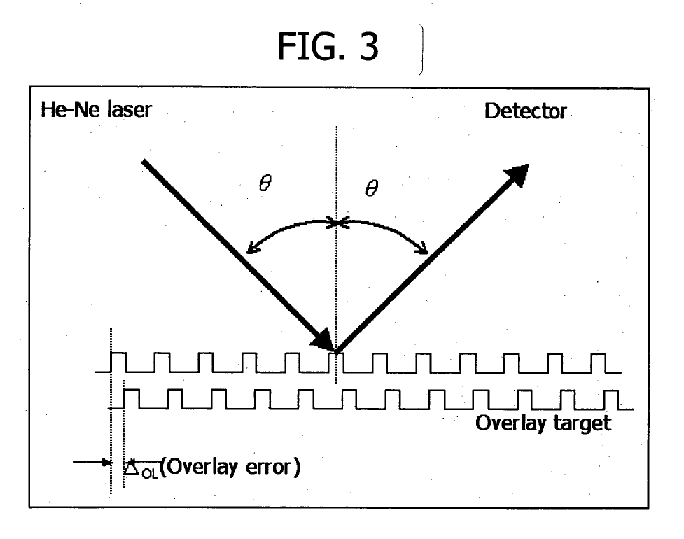

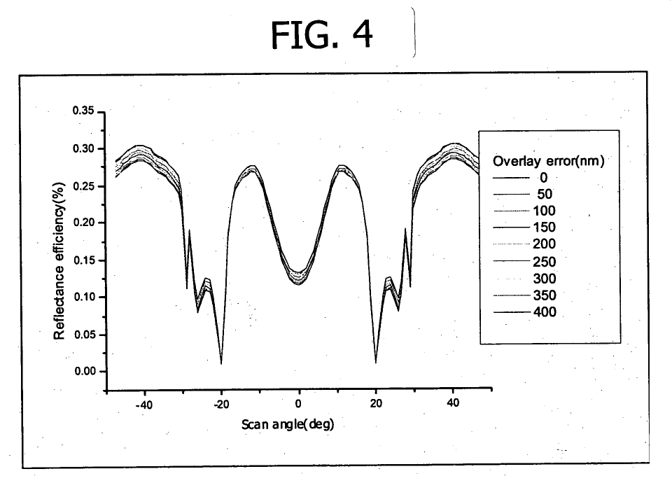

FIG. 3 shows angular scatterometry on the substrate of FIG. 2. Other types of scatterometry systems may similarly be used. Angular scatterometry is a 2-θ system. The angle of an incident laser beam and the measurement angle of a detector are varied simultaneously, and accordingly a diffraction signature is obtained. Before optimizing the grating target, ASD is defined as the average standard deviation, to describe the discrepancy among signatures, which have different overlay offsets, as below.

$$ASD = \frac{1}{{θ}_{final} - {θ}_{initial}} {\sum }_{{θ}_{i} = {θ}_{initiali}}^{{θ}_{final}} δ ( {θ}_{i} ) , where \\ δ ( {θ}_{i} ) = \sqrt{{\sum }_{Δ {OL}_{j}}^{J} {( R ( {θ}_{i} , {Δ}_{{OL}_{j}} ) - \overline{R ( {θ}_{i} , {Δ}_{{OL}_{j}} )} )}^{2} / J} \qquad ( 1 )$$

Where θᵢₙᵢₜₐₗ is the initial scan angle; θ_{final} is the final scan angle; R(θ_{I}Δ_{OL}_{ⱼ}) is the reflective signature while overlay error is Δ_{OLj}; δ(θ_{I}) is the standard deviation of R(θ_{I}, Δ_{OLj})|_{j=1,2, . . . ,J}, while the incident angle is θᵢ. So, the meaning of ASD is the discrepancy among the signatures, which have different overlay offsets. Larger ASD means greater discrepancy among the signatures, and hence that the metrology system can more easily identify different overlay offsets. Larger ASD therefore means that measurement system is more sensitive to overlay error, and measurement quality is improved. FIG. 4 shows an example for the reflective signatures of angular scatterometry.

In this simulation, the thickness of each layer and the refractive index and extinction coefficient of material are listed as Table 1. The range of grating pitch is from 0.1 um to 2 um, and that of the grating L:S ratio is from 1:9 to 9:1. The overlay offset is intentionally designed at around ¼ pitch, and the increment of overlay offset is 5 nm. Finally, several common lasers were selected, including an Argon-ion laser (488 nm and 514 nm), an HeCd laser (442 nm), an HeNe laser (612 nm and 633 nm), and a Nd:YAG (532 nm) laser.

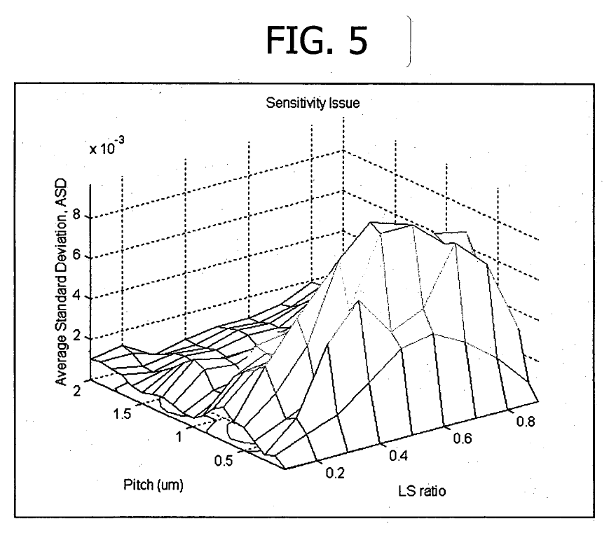

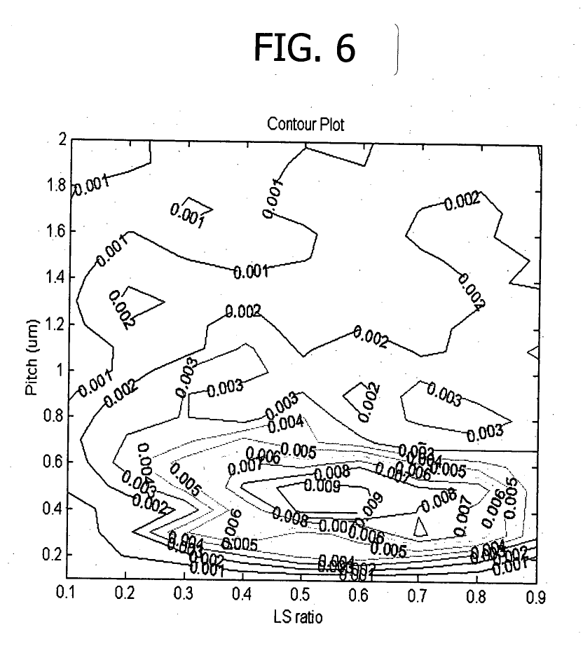

FIG. 5 shows the simulation results for an incident wavelength of 633 nm. FIG. 6 is the contour plot of FIG. 5. The maximum ASD is 0.010765 at pitch=0.46 nm and LS ratio=48:52. Table 2 lists the simulation results for different incident wavelengths. For this target, the maximum ASD is 0.015581 at incident wavelength=612 nm, pitch=0.4 um, and LS ratio=48:52. Comparing the maximum ASD with the mean ASD in this range (pitch 0.1˜2 um, LS ratio 1:9˜9:1), we get a magnification of about 21.5. According to the above procedures, we can obtain an optimal pitch, LS ratio, and incident wavelength, and at these conditions the discrepancy among signatures is the largest. This means that this target with these optimal parameters is the most sensitive to overlay measurement.

TABLE 1

| | material | thickness | | n | k |
|---|---|---|---|---|---|
| Top layer | PR | 7671.8 | A | 1.62399 | 0 |
| Inter layer | Poly | 1970.6 | A | 3.925959 | 0.0594 |
| Bottom layer | SiO2 | 494 | A | 1.462589 | 0 |

| | | | | |
|---|---|---|---|---|
| Substrate | Silicon | — | 3.866894 | 0.019521 |

TABLE 2

| wave- | | | | Max | | |
|---|---|---|---|---|---|---|
| length | | | | ASD | pitch | L/S |
| (nm) | ASD(min) | ASD(mid) | ASD(max) | at | (um) | ratio |
| 442 | 1.02E−05 | 0.000144 | 0.002481 | | 0.24 | 54:46 |
| 488 | 1.36E−05 | 0.000786 | 0.007731 | | 0.28 | 44:56 |
| 514 | 1.77E−06 | 0.000866 | 0.010951 | | 0.26 | 48:52 |
| 532 | 7.43E−07 | 0.000933 | 0.010542 | | 0.28 | 58:42 |
| 612 | 2.55E−08 | 0.001998 | 0.015581 | | 0.4 | 48:52 |
| 633 | 1.42E−08 | 0.001853 | 0.010765 | | 0.46 | 48:52 |

| | |
|---|---|
| ASD(mid) among | 0.000726 |
| all wavelength | |

| | |
|---|---|
| Magnification | 21.4690569 |

With an angular scatterometer system, ASD is expressed as:

$$ASD = \frac{1}{{θ}_{final} - {θ}_{start}} {\sum }_{{θ}_{i} = {θ}_{starti}}^{{θ}_{final}} δ ( {θ}_{i} ) , \\ δ ( {θ}_{i} ) = \sqrt{{\sum }_{Δ {OL}_{j}}^{J} {( R ( {θ}_{i} , {Δ}_{{OL}_{j}} ) - \overline{R ( {θ}_{i} , {Δ}_{{OL}_{j}} )} )}^{2} / N}$$

With a reflectometer system, ASD is expressed as:

$$ASD = \frac{1}{{λ}_{final} - {λ}_{start}} {\sum }_{{λ}_{i} = {λ}_{starti}}^{{λ}_{final}} δ ( {λ}_{i} ) , \\ δ ( {λ}_{i} ) = \sqrt{{\sum }_{Δ {OL}_{j}}^{J} {( R ( {λ}_{i} , {Δ}_{{OL}_{j}} ) - \overline{R ( {λ}_{i} , {Δ}_{{OL}_{j}} )} )}^{2} / N}$$

With an ellipsometer system, ASD is expressed as:

$${ASD}_{ψ} = \frac{1}{{λ}_{final} - {λ}_{start}} {\sum }_{{λ}_{i} = {λ}_{starti}}^{{λ}_{final}} δ ( {λ}_{i} ) , \\ δ ( {λ}_{i} ) = \sqrt{{\sum }_{Δ {OL}_{j}}^{J} {( ψ ( {λ}_{i} , {Δ}_{{OL}_{j}} ) - \overline{ψ ( {λ}_{i} , {Δ}_{{OL}_{j}} )} )}^{2} / N}$$

$${ASD}_{Δ} = \frac{1}{{λ}_{final} - {λ}_{start}} {\sum }_{{λ}_{i} = {λ}_{starti}}^{{λ}_{final}} δ ( {λ}_{i} ) , \\ δ ( {λ}_{i} ) = \sqrt{{\sum }_{Δ {OL}_{j}}^{J} {( Δ ( {λ}_{i} , {Δ}_{{OL}_{j}} ) - \overline{Δ ( {λ}_{i} , {Δ}_{{OL}_{j}} )} )}^{2} / N}$$

The methods described may be used with existing scatterometry systems. The material properties of the substrates to be measured (e.g., type and thickness of the layers, and sidewall angles), and the wavelength of the light to be used, may be entered into the scatterometry system computer, or another computer. The computer then determines e.g., which grating pitch and line:space ratio will provide the maximum sensitivity for that specific type of substrate. The reticle is then made to print that grating onto the substrates. Then, when overlay off set measurements are made on those substrates, the sensitivity of the system is improved, and better measurements can be made.

Thus, novel methods, systems and articles have been shown and described. The descriptions above of maximum, optimum, etc. also of course apply to improved, even if less than maximum, sensitivity, etc. Various changes and substitutions may of course be made without departing from the spirit and scope of the invention. The invention, therefore, should not be limited, except by the following claims, and their equivalents.

1. A method for designing an overlay mark, the method comprising:
illuminating an overlay mark with a probe beam;
measuring the diffraction resulting from the interaction of the probe beam and overlay mark;
selecting the parameters of the overlay mark to be optimized to increase the sensitivity of overlay measurement;
using an optimization algorithm to optimize the parameters of the overlay mark, which makes the most sensitivity of overlay measurement.

2. The method of claim 1 wherein the overlay mark includes at least a top grating target layer and a bottom grating target layer.

3. The method of claim 2 wherein the grating target is a one-dimension periodic structure.

4. The method of claim 2 wherein the grating target is a two-dimension periodic structure.

5. The method of claim 1 wherein the probe beam is generated from a laser source and diffraction is measured as a function of scan angle of the probe beam.

6. The method of claim 1 wherein the probe beam is generated from a broadband source and diffraction is measured as a function of wavelength.

7. The method of claim 1 wherein one of the selected parameters of the overlay mark is the pitch of the grating target.

8. The method of claim 1 wherein one of the selected parameters of the overlay mark is the line-to-space ratio of the grating target.

9. The method of claim 1 further including
calculating the average standard deviation (ASD) of diffraction signatures at pitch=p and line-to-space ratio=r of an overlay grating target; and
with the optimization method determining the maximum ASD value, where overlay measurement is the most sensitive.

10. A method for designing an overlay target grating for use in scafterometry measurements of a sample, comprising:
A. selecting at least one sample layer parameter, including one or more of the layer material, the film thickness, and the sidewall angle of the patterned elements on the layer;
B. selecting a first target grating, with the first target grating having a first target characteristic which will be varied in the steps below;
C. calculating an average standard deviation (ASD) of light reflected off of a mathematically modeled target having the first target grating characteristic by averaging standard deviation of shifting overlay offset of the first target characteristics over a range of incident light angles;
D. changing the first target grating characteristic by a first increment;
E. repeating step C;
F. comparing the ASD from step C with the ASD from step E and determining which is larger, and them taking the larger ASD target grating characteristics as the new starting grating characteristics;
G. repeating steps C through F in an iterative process, until a maximum desired ASD is derived; and then;
H. designing a real target to be used on the substrate, with the real target having a target grating characteristic substantially equal to the characteristic corresponding to the maximum desired ASD.

11. The method of claim 10 with each layer parameter corresponding to a constant determined from a look up table.

12. The method of claim 10 where the first target grating characteristic is selected by either using a known standard target to start with, or by making a best educated guess of what the target should be—based on the material parameters.

13. The method of claim 10 where the first target characteristic is pitch and/or line to space ratio.

14. The method of claim 10 wherein overlay offset is shifted in increments of about 2-8, 3-7, 4-6, or 5 nm.

15. The method of claim 10 where the ASD is calculated using known mathematical equations for modeling reflectance from the first target grating.

16. The method of claim 10 where the first target grating characteristic is changed by a first increment by shifting the pitch and line/space ratio of the target.

17. The method of claim 10 with all of steps A through G performed mathematically using software and without performing any actual measurements on a real target.

18. The method of claim 10 where the target is adapted for use in performing scatterometry using an angular scatterometer, a reflectometer, or an ellipsometer.

19. A method for designing an overlay target grating for use in scatterometry measurements of a sample, comprising:
A. selecting sample layer parameters, including one or more of the layer material, the film thickness, and the sidewall angle of the patterned elements on the layer, and with each layer parameter corresponding to a constant determined from a look up table, and with the constants to be used in a target optimizing algorithm;
B. selecting a first target grating, by either using a known standard target to start with, or selecting based on the material parameters, with the first target grating having a first pitch and line to space ratio which will be varied in the steps below;
C. calculating an average standard deviation (ASD) of light reflected off of a mathematically modeled target having the first pitch and line/space ratio, by averaging standard deviations resulting from shifting overlay offset in 5 nm increments of pitch and line/space ratio), over a range of incident light angles, by using known mathematical equations for modeling reflectance from the first target grating;
D. changing the first pitch and line to space ratio by a first increment;
E. repeating step C;
F. comparing the ASD from step C with the ASD from step E and determining which is larger; then taking the larger ASD target grating characteristic as the new first pitch and line to space ratio;
G. repeating steps C through F in an iterative process until a substantially maximum desired ASD is derived; and
H. designing a real target having a pitch and line to space ratio substantially equal to the first pitch and line to space ratio corresponding to the maximum ASD arrived at in step G.

20. The method of claim 19 where steps C-F are repeated until ASD no longer increases.

21. A method for performing scatterometry on a layer or substrate including applying the target designed in step H of claim 10 onto the layer or substrate, illuminating the target with a light beam, measuring light reflected from the target, and then processing the reflected light to determine an overlay error.

22. A substrate for the manufacture of microelectronic, micromechanical, or micro-electromechanical device, with the substrate having a scatterometry target designed using the steps described in claim 10.

23. A method for calculating optimized parameters of an overlay mark, comprising:
calculating the average standard deviation (ASD) of diffraction signatures at pitch=p and line-to-space ratio=r of an overlay grating target;
using an optimization method to determine the maximum ASD value, where overlay measurement is the most sensitive.

24. The method of claim 23 wherein one of the optimization methods is a simplex method or a random walk method.
